(19) United States
(12) Patent Application Publication
(10) Pub. No.: US 2016/0085348 A1
(43) Pub. Date: Mar. 24, 2016

(54) APPLICATION HOST WITH DISTRIBUTED REMOTE INPUT AND OUTPUT INTERFACES

(71) Applicant: UV Networks, Inc., Cupertino, CA (US)

(72) Inventors: Edward A. Krause, Saratoga, CA (US); Peter A. Monta, Palo Alto, CA (US); Michael Lee, Saratoga, CA (US)

(73) Assignee: UV NETWORKS, INC., Cupertino, CA (US)

(21) Appl. No.: 14/863,405

(22) Filed: Sep. 23, 2015

Related U.S. Application Data
(60) Provisional application No. 62/054,300, filed on Sep. 23, 2014.

(51) Int. Cl. G06F 3/041

(52) U.S. Cl. CPC G06F 3/0412

(57) ABSTRACT

A system has an application host and a remote host with a touch-sensitive display. Video from the application host is extracted, compressed, forwarded, decompressed and reproduced on a touch-sensitive display. Touch information from the touch-sensitive display is received by the remote host and forwarded to the application host. A plurality of remote devices each hosts one or more sensors. Information from the one or more sensors on each remote device is forwarded to the application host and becomes usable to applications as if they were native sensors. Two or more sensors are of the same type, where each of said same sensors is hosted by a different remote device, and each of said same sensors is accessible to a single application running on the application host.

### BACKGROUND OF THE INVENTIONS

1. Technical Field

The present inventions relate to application hosts and, more particularly, relate to application host interaction with remote devices for interaction.

2. Description of the Related Art

In the past, most computer applications operated on user input data received from a keyboard and mouse and generated output information in the form of imagery on displays, sound from speakers, or more general data copied to storage devices or communication networks. More recently, computer applications are commonly executed on smaller mobile devices complete with a more diverse set of user interfaces better adapted for mobility and convenience. For example, these user interfaces often include multi-touch-sensitive display screens, cameras, microphones, global positioning systems, motion sensors such as accelerometers, gravity sensors, gyroscopes and rotational vector sensors, position sensors such as orientation sensors and magnetometers, and environmental sensors for temperature, pressure, illumination, and humidity.

Another advantage of mobile devices is the infrastructure that has been created for the creation and distribution of application software (apps). Currently, a large percentage of new software is in the form of apps targeting the very large population of mobile devices. In order to run properly, most of these apps require a standard set of user input devices, including a touch-sensitive display, camera, microphone, as well as position and motion sensors.

Mobile devices are often in the form of smart phones or tablets and are typically based on a single powerful System-On-Chip (SOC) with multiple CPU and DSP cores, graphics processors, video codecs, memory sub-systems, and high speed interfaces. The capabilities of such SOCs continue to improve at a very rapid pace. Unfortunately, even though there are many applications that could benefit from the new software infrastructure, user interfaces and mobile sensors, there may be various reasons that a particular application may be unsuitable for operation on the mobile platform. For example, if the hardware associated with the application includes vast storage libraries, an elaborate sound system, or one or more large displays, then it is not likely to be mobile. Furthermore, a large display may not be suitable as a touch-sensitive user input device if the preferred viewing distance exceeds the length of the users arm. The mobile platform may also be unsuitable if the application requires hardware that is fragile or expensive, or if the hardware is to be positioned near people or objects that are not necessarily co-located with the user. Alternatively, the application may require input from multiple users positioned at one or more different locations. In this case, the most efficient and convenient option may be to separate the application host from all users and place it in a location with more convenient access to resources such as data storage or fast and inexpensive network connectivity.

### BRIEF DESCRIPTION OF THE DRAWINGS

The present inventions are illustrated by way of example and are not limited by the accompanying figures, in which like references indicate similar elements. Elements in the figures are illustrated for simplicity and clarity and have not necessarily been drawn to scale.

The details of the preferred embodiments will be more readily understood from the following detailed description when read in conjunction with the accompanying drawings wherein:

FIG. 1 illustrates a block diagram of an application platform according to embodiments of the present inventions;

FIG. 2 illustrates a diagram of the software stack layers running on the CPU cores of a System-On-Chip SOC according to one example in embodiments of the present inventions;

FIG. 3 illustrates a diagram of alternate software stack layers running where drivers are replaced with virtual drivers according to an example in embodiments of the present inventions;

FIG. 4 illustrates a block diagram of the media entertainment system including an application host in embodiments of the present inventions;

FIG. 5 illustrates a diagram of an example of a remote device in embodiments of the present inventions;

FIGS. 6 and 7 illustrate respective block diagrams of a virtual interface for the process between application host of FIG. 4 and remote host with touch-sensitive display of FIG. 5; and

FIG. 8 illustrates a diagram of an application platform system with a media entertainment center establishing connections to a plurality of remote hosts according to an example embodiment of the present inventions.

### DETAILED DESCRIPTION OF THE PREFERRED EMBODIMENTS

It is possible to achieve the infrastructure and user interface advantages of the mobile device even when an application cannot be conveniently ported to the mobile device platform. The solution is to separate the IO devices from the platform that is hosting the application. This can be done by substituting a virtual device driver in place of the original device drivers servicing the IO hardware. Then when a particular IO device is enabled, the virtual device drivers communicates with the remote platform that is hosting the displaced IO hardware, and information is exchanged. At the same time, the virtual device driver communicates with the local operating system as if it were a conventional device with attached IO hardware.

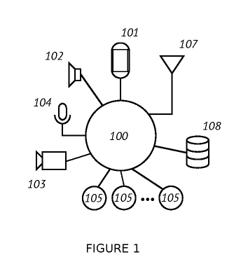

FIG. 1 illustrates a block diagram of an application platform according to embodiments of the present inventions. An example of a typical application platform is shown in FIG. 1. In this case, the platform includes a System-On-Chip SOC 100 with interfaces to touch-sensitive display 101, one or more speakers 102, one or more cameras 103, at least one microphone 104, motion, position, and environmental sensors 105, and flash memory 108. The flash memory be either removable, permanently installed, or a combination of both removable and installed memory. Video is forwarded from SOC 100 to touch-sensitive display 101 via one or more high speed serial buses such as DSI or HDMI, or by a single parallel bus clocked at a lower speed Similarly video is forwarded from camera 103 to the SOC using one or more high speed serial buses such as CSI or HDMI, or by a single parallel bus. Interfaces from SOC 100 to speaker 102 and from microphone 104 to the SOC are typically based on the I2S or Slimbus audio interface specifications. The video can be a sequence of images and the interval between images can be irregular. Touch information forwarded from touch-sensitive display 101 to SOC 100, or sensor information forwarded from motion, position, and environmental sensors 105 to the SOC are typically implemented using low speed communication interfaces such as I2C. Flash memory 108 is coupled to SOC 100, either using a simple address and bidirectional data parallel bus format, or standardized serial formats such as SPI or USB. Finally, SOC 100 includes one or more network connections 107, which may include wired ethernet and/or one or more wireless formats such as Bluetooth and the 802.11 family of Wifi specifications. Each of the various interfaces to SOC 100 may also include wired interrupt connections for notification of new pending events.

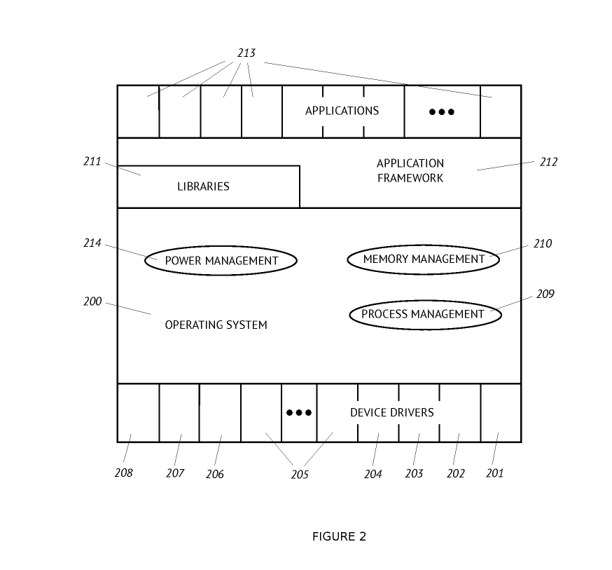

FIG. 2 illustrates a diagram of the software stack layers running on the CPU cores of SOC 100 according to one example in embodiments of the present inventions. This particular example represents a typical Android environment based on the Linux operating system 200. Communication with the hardware is handled by Linux device drivers including display driver 201, audio output driver 202, camera driver 203, microphone driver 204, motion, position, and environment sensor drivers 205, input driver 206, network driver 207, and flash memory driver 208. The forms of user input not handled by the various sensor drivers 205 include keyboard key presses, mouse clicks and touch events and these are all handled by input driver 206.

In addition to the device drivers, the operating system also includes power management module 214, process management module 209, and memory management module 210. Generally, a software stack will also include a collection of libraries 211, and often an application framework layer such as Android 212 which serves as an interface between the operating system 200 and a defined set of APIs for interfacing with software applications 213. In this example, each software application 213 may represents a different Android app.

The preceding system described with reference to FIGS. 1 and 2 is not only conventional, but typical of a mobile platform such as a smart phone or tablet. Next, a modification in accordance with the invention will be described using a common home media entertainment system as an example. In this case, the goal is to enable the media entertainment system to run the same software applications and to be configured and monitored in the same way as the versatile mobile platform described previously and illustrated in FIGS. 1 and 2.

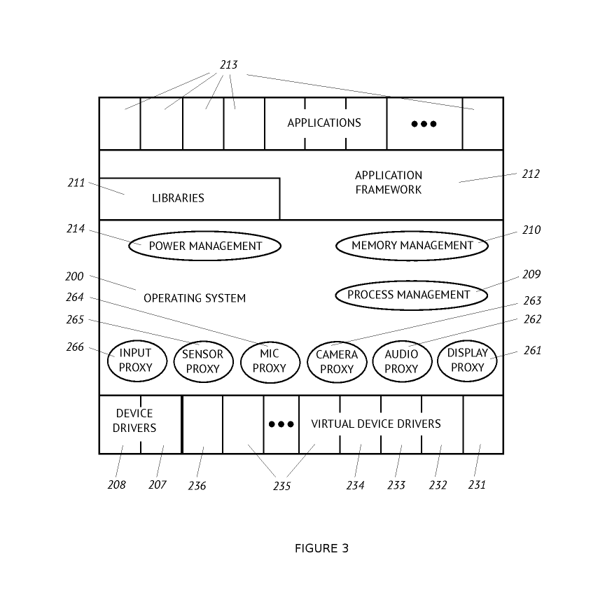

FIG. 3 illustrates a diagram of alternate software stack layers running where drivers are replaced with virtual drivers according to an example in embodiments of the present inventions. The modifications to the software stack are shown in FIG. 3 where display driver 201, audio driver 202, camera driver 203, microphone driver 204, sensor drivers 205, and input driver 206 have all been removed. Instead, they are replaced with virtual display driver 231, virtual audio driver 232, virtual camera driver 233, virtual microphone driver 234, virtual sensors drivers 235, and virtual touch input driver 236, respectively. Proxy processes have also been added to forward data between the network interface driver and the various virtual drivers. Specifically, display proxy 261 forwards compressed video data from virtual display driver 261 to network driver 207, and similarly, audio proxy 262 forwards audio data from virtual audio driver 232 to network driver 207. All other proxy processes are for forwarding data in the opposite direction. For example, camera proxy 263 forwards compressed video from network driver 207 to virtual camera driver 233, mic proxy 264 forwards microphone data from network driver 207 to virtual microphone driver 234, sensor proxy 265 forwards motion, position, and environmental sensory data from network driver 207 to the virtual sensor drivers 235, and input proxy 266 forwards input data such as touch information from network driver 207 to virtual input driver 236. In all other respects, virtual drivers 231, 232, 233, 234, 235, and 236 appear to the operating system as conventional device drivers with attached display, audio emitters, camera, microphone, sensor, and touch pad hardware, respectively.

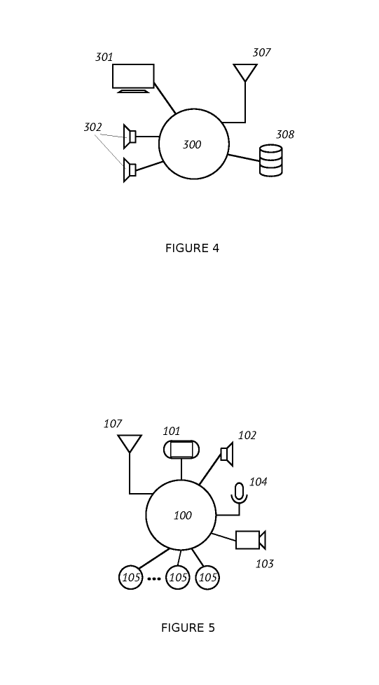

FIG. 4 illustrates a block diagram of the media entertainment system including an application host 300 in embodiments of the present inventions. This may be an SOC in the same style as SOC 100 described previously with reference to FIG. 1. The application host forwards video to display device 301 using an interface such as HDMI, and forwards audio to one or more speakers 302, using a wired interface as an example. Note that the same HDMI connection to video display device 301 can also accommodate audio signals to speakers 302. The display of the application host can be an HDMI capable display or a high definition television HDTV and the remote host can be a handheld mobile device with a touch-sensitive flat-screen. Also the application host can use an audio port 302 for playing sound associated with the application running on the application host. Application host 300 is also interfaced to media storage library 308 which may include sufficient storage to accommodate many hours of video content in addition to photos and general data. The interface to the storage library may be in accordance with the USB or SATA specifications.

Instead of infra-red or RF interfaces to conventional remote controlling devices, application host 300 uses network interface 307 to exchange information with remote devices. The form of network interface may be the same as network interface 107 described previously with reference to FIG. 1.

FIG. 5 illustrates a diagram of an example of a remote device in embodiments of the present inventions. It includes remote host module 100 which may be the same as SOC 100 in FIG. 1. Peripheral devices 101, 102, 103, 104, 105, and 107 are also the same as the corresponding peripheral devices in FIG. 1. In fact, the conventional mobile tablet or smart phone is the preferred embodiment of the remote device used for interfacing with the media entertainment system in FIG. 4. Note that output device 102 may be one or more speakers, a headset, or any combination of sound transducing devices. The implementation of monitoring and user input functions may be conveniently implemented as a software app running on remote host 100.

Touch-sensitive display 101 is an effective user input device on a smart phone or tablet, however its usefulness as a controlling device for application host 300 (FIG. 4) will be very limited unless additional steps are taken. If touch information is to be used as a mechanism for controlling the video that is generated and displayed at device 301, then this same video must be extracted and forwarded from application host 300 to remote host 100 using network interfaces 307 and 107 respectively. The video extracting and forwarding implementation details are critical. Not only must video quality be preserved, but latency must be minimized as much as possible or responsiveness will be sacrificed. An efficient implementation with latencies under 200 ms has only recently become possible using commonly available mobile devices.

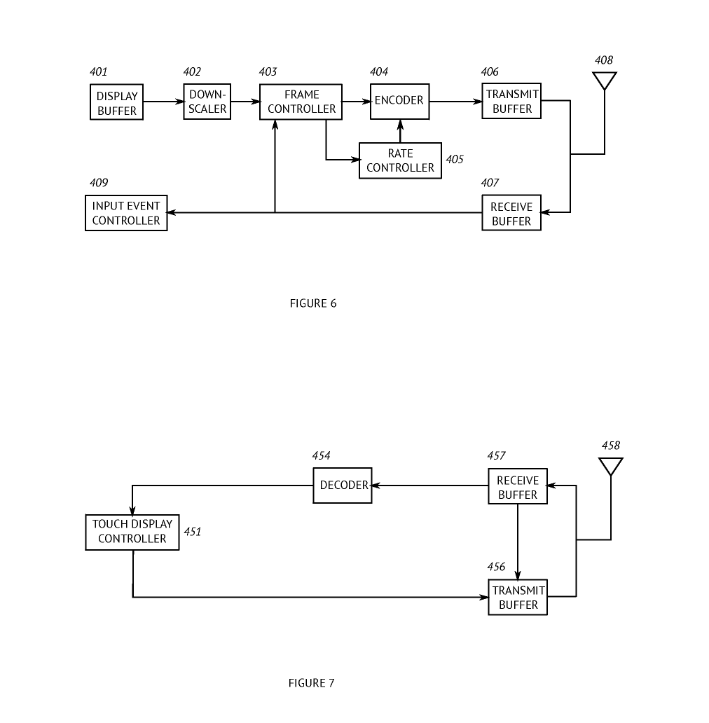

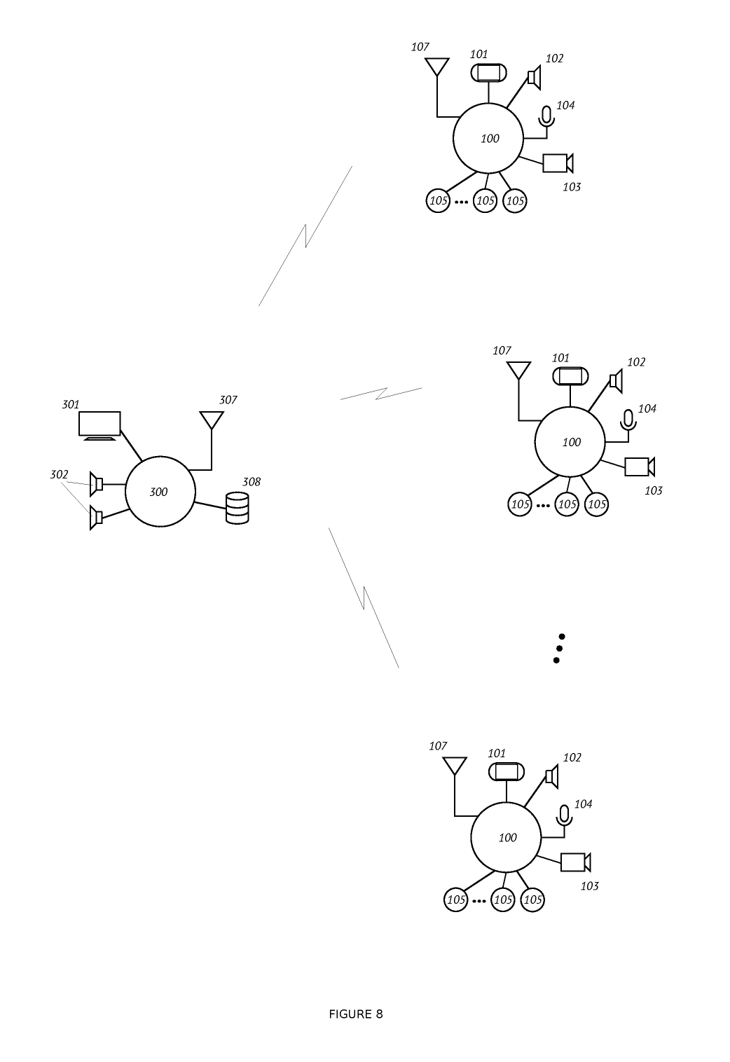

FIGS. 6 and 7 illustrate respective block diagrams of a virtual interface for the process between application host 300 of FIG. 4 and remote host with touch-sensitive display 101 of FIG. 5 in embodiments of the present inventions. A first step is to capture a copy of the video frames produced and stored in the internal frame buffer 401 of the application host. Depending on the native resolution, it may be necessary to downscale the resolution of each extracted video frame and this is handled by downscaler 402. For this purpose, a downscaled pixel resolution of approximately 1280×720 is quite sufficient, although significantly lower resolutions will be preferred when network bandwidth is limited, as is often the case when video must be forwarded over long distances using the general internet. Many modern SOCs running recent versions of operating systems such as Linux/Android are fully capable of capturing and downscaling video using native hardware instead of software. Unfortunately, the most efficient interfaces may not be sufficiently exposed to the user, and in this case, custom platform modifications are recommended.

Once, the video frames are extracted and downscaled to a suitable resolution, they are forwarded to video encoder 404 which compresses the signal to avoid saturating the transmission network. Modern SOCs include hardware implementations of common video codecs such as H.264, thereby reserving CPU resources for other tasks. In order to minimize latency, the encoder should be configured to process all frames in sequence without reordering. The video can be a sequence of images and the interval between images can be irregular. Although frame reordering can often result in incremental improvements in coding efficiency, the reordering process introduces significant delays at both the encoder and the downstream decoder. Another performance optimizing step can be taken if using a reliable network protocol such as TCP, and an encoding/decoding compression format that is immune to regeneration losses. H.264 is an example of such a format where the reconstructed images at the decoder will always be bit-for-bit identical to the corresponding images maintained at the encoder. In such cases, it is advantageous to configure encoder 404 to avoid inserting I-frames except when necessary for synchronization with a new remote device connection. This will further reduce the data rate of the compressed stream and help to minimize network congestion.

After encoding, the compressed video data stream is forwarded to transmit buffer 406 for transmission to the remote device. The video signal is then conveyed via network interface 408 of the application host to network interface 458 of the remote host system that is illustrated in FIG. 7. The compressed video data received at the remote host is deposited in receive buffer 457 and video images are subsequently reconstructed at decoder 454 and written to the internal frame buffer of touch display controller 451. The implementation of the decoding and video reconstruction steps is internal to the SOC but existing software environments such as Android enable convenient setup and management of such processes using a simple software app running on remote host 100. Currently, many mobile devices offer APIs at the app layer permitting low-latency access to native hardware decoders such as H.264.

Depending on the video compression rate and the network quality, transmission delays may sometimes occur. Such conditions must be detected and addressed, otherwise the user experience may be severely degraded. In the preferred embodiment, a reliable network protocol such as TCP is used to insure that data loss does not occur. However, video data may back up at transmit buffer 406 of FIG. 6 while awaiting acknowledgment of preceding video data. In some cases, portions of the signal will need to be retransmitted one or more times before successful transmission is confirmed. In such cases, the best option is to discard incoming video frames, but this must be done before the frames are encoded. Otherwise, if a frame is dropped after encoding, severe video corruption is likely to occur unless the state of the encoder is fully reset. For this reason, it is important to respond quickly before frames begin to queue up at the network interface. A preferred solution is implemented using frame controller 403 shown in FIG. 6. In this case, the frame controller maintains a limited number of encoding slots. If a slot is available when a next video frame is received from downscaler 402, then the slot is assigned to the video frame which is then forwarded to encoder 404. Once claimed, a slot cannot be reassigned until notification of successful transmission has been received. When notification of successful completion is received, the state of the corresponding slot is cleared and it once again becomes available for reassignment. Such notifications of successful transmission may be extracted from the network communication protocol (for example TCP) but often it is easier to implement a new layer of communication between application host 300 and remote host 100 as further illustrated in FIGS. 6 and 7. When a compressed video frame is received in its entirety at receive buffer 457, a notification message is forwarded to transmit buffer 456 which forwards the message back to the application host via network interfaces 458 and 408. The notification message is received at receive buffer 407 and then forwarded to frame controller 403. The frame controller then releases the slot corresponding to the video frame identified by the notification message.

If there are no available slots when the next video frame arrives at frame controller 403, then the arriving frame is simply discarded. This event may also serve as a trigger for a video encoder rate control loop. The dropped frame event indicates that the encoder is producing data at a rate that is higher than the network can accommodate. One way to reduce the probability that subsequent frames will also need to be dropped, is to adjust the encoder so that the compression ratio is increased. Similarly, if there have been no dropped frames during a prolonged interval, then the compression ratio can be gradually reduced until either a frame drop event occurs or until the original quality level is restored. In this example, rate control adjustments are implemented using rate controller 405 which receives dropped frame notifications from frame controller 403, and sends new rate information to encoder 404 whenever a correction is needed. Such rate adjustment strategies are quite similar to the rate adjustment methods used with network transmission protocols such as TCP, and therefore the same sort of adjustment algorithms can be adopted.

Once touch-sensitive display 451 of the remote system is displaying the same video as display buffer 401 of the media entertainment system, the operation of the touch control becomes particularly effective. Touch information detected by touch controller 451 can now be correlated with the overlayed video image and conveyed back to input event controller 409 of the application host via transmit buffer 456, network interfaces 458 and 408, and receive buffer 407.

Generally the latency that the touch information incurs during the return path from remote host to application host will be considerably less than the latency incurred during transmission of the video signal in the opposite direction. Therefore, the system may appear more responsive to the user if viewing display 301 (FIG. 4), than it may appear if the user is viewing touch-sensitive display 101 (FIG. 5). However, the option of viewing display 301 may not exist if remote touch-display device 101 is not in the immediate vicinity of display 301, or at times when precise positioning of the touch events is important.

The touch-sensitive display device is an example of an input sensor that requires information from the source before it becomes particularly useful. Of course, if the user and corresponding remote host are physically separated from the media entertainment system, then the forwarding of both video and audio are important even when engaging non-interactive applications. Therefore application host 300 also includes the ability to extract and forward audio signals in a way that is similar to the video example in FIGS. 6 and 7. In this case, the same audio signal that is being forwarded to speakers 302 of the media entertainment system in FIG. 4 is captured and reproduced at the one or more speakers 102 of the remote system in FIG. 5. In some cases, it may be advantageous to down-mix surround sound formats, which typically contain 6 or 8 audio channels, and convert to two-channel stereo or a single-channel mono format. The extracted audio is then preferably encoded using one of many audio encoding formats such as AAC. The resulting encoded audio signal is then forwarded to remote host 100 via network interfaces 307 and 107. Remote host 100 subsequently decodes the audio signal using an internal software or hardware decoder corresponding to the particular compression format, and finally forwards the decoded audio signal to the one or more speakers 102.

The application host can also accommodate applications such as video conferencing requiring the use of one or more cameras. Since application host 300 lacks local camera resources, all camera requests are simply forwarded to remote host 100 using network interfaces 307 and 107. For example, if a front or back camera is to be enabled, then remote host 100 is instructed to initialize and enable the corresponding front or back camera 103. The video signal from the enabled camera is then forwarded back to application host 300 using network interfaces 107 and 307.

However, as with the touch-sensitive video display, the signal generated by the camera may exceed the rate supported by the network, and therefore an encoding step should be included at remote host 100, and a corresponding decoding step should be included at application host 300.

The application host also accommodates conferencing, speech recognition, and other applications requiring the use of a microphone. In this case, it is preferable to locate the microphone at the remote system where it will be in close proximity to the user. For this reason, the media entertainment system example does not include microphones, and instead all microphone requests are forwarded to remote host 100 via network interfaces 307 and 107. When a microphone enable request is received, remote host 100 causes microphone 104 to be initialized and enabled, and the audio signal from the microphone is forwarded to application host 300 via network interfaces 107 and 307. Optionally, the audio signal may be encoded at remote host 100 and subsequently decoded at application host 300. However, it may be preferable to forward the audio in uncompressed form in cases where latency and quality are critical and sufficient network bandwidth is available.

As with the video camera and audio microphone, any motion, position, and environmental sensors are more effectively placed at the remote system than at the media entertainment system of this example. In this way, applications requiring use of such sensors are fully accommodated at application host 300, which forwards such requests to remote host 100 via network interfaces 307 and 107. Remote host 100 responds by initializing and enabling the corresponding sensor 105, and then forwarding retrieved sensor data back to application host 300 via network interfaces 107 and 307. As with the video signal from the camera and the audio signal from the microphone, the control and management of sensor data is easily implemented as a software app running on remote host 100.

Although virtual device drivers may appear to the operating system as conventional device drivers, there is a complication related to initialization. In most conventional systems, the camera, microphone, and sensor hardware are assumed to be non-removable and therefore the device drivers are probed only once during system initialization. In a mobile environment where power conservation is very important, the device may remain powered down or forced into a standby state when not in use, but even in this case, the capabilities of the device are already recorded and not expected to change. Therefore, additional kernel adjustments are often necessary to accommodate the more dynamic environment where remote sensors may appear on the network at certain times and disappear at others. Otherwise, the operating system may falsely believe that a particular device is always available once detected at boot time, or never available if registration at boot time did not occur. Also problematic is the possibility that sensor capabilities may change after initial detection occurs. For example, if the mobile device representing the remote system in FIG. 5 is shutdown or disconnected from the network, and if it is subsequently deemed convenient to substitute a different model of mobile device in its place, then problems may occur. For example the operating system may have already registered the capabilities of the camera hardware and it may attempt to configure a particular resolution that may not be supported by the substituting device. In this case, an attempt to synchronize with the resulting video signal is not likely to be successful.

The only proper solution to this problem is to adjust the operating system as needed to support the dynamic reconfiguration of devices. The registering of devices should be deferred until a connection is established and unregistering should occur immediately if the connection is lost. In some cases, it may be simpler to not register the device at all until a query request is received from a running application.

Most operating systems already include support for certain removable hardware such as USB storage or camera devices, but this support must be extended to all remote interfaces.

The conversion of the host platform from a self-contained system with fixed JO devices to a modular system supporting dynamically changeable remote devices, paves the way for additional features and capabilities. It now becomes possible to scale the system by adding additional remote devices, each offering additional sensors and monitoring capabilities. Each added device could be a new smart phone or tablet running a simple software app to share its own sensors and emitters with the interconnected host platform. The illustration in FIG. 8 serves as an example.

FIG. 8 illustrates a diagram of an application platform system with a media entertainment center establishing connections to a plurality of remote hosts according to an example embodiment of the present inventions. In this case, the media entertainment center establishes connections to a plurality of remote hosts and gains access to multiple remote touch-sensitive displays 101, speakers 102, cameras 103, microphones 104, and motion, position, and environment sensors 105. Typically, the video that is displayed at media display device 301 and the audio that is emitted at speakers 302 would now be forwarded and reproduced at each touch-display device 101 and remote speaker 102 respectively, corresponding to each of the remote devices.

In the case of input sensors, the simplest option is to restrict access to each class of sensor such that only one remote device is able to establish a connection at a time. For example, if the user associated with a certain remote device launches an application requesting use of a front-facing camera, and if this camera interface is not already in use, then the front-facing camera of the user's own remote device would be selected and enabled. However, the options become more interesting once the operating system and the app interfaces are adjusted to support multiple instances of each type of sensor. For example, the home media system could then simultaneously support multiple front-facing cameras, multiple rear-facing cameras, and multiple microphones distributed across different locations. Applications running on application host 300 could utilize all of these additional sensors once the APIs are sufficiently generalized to make them available.

As a further example, consider the gaming application where a ball is maneuvered through a maze by tilting a hand-held device to produce motion in the desired direction. If there are multiple hand-held devices, each corresponding to a particular remote platform in FIG. 8, then an application could be designed such that each remote platform is assigned a different ball, with each ball responding only to the sensory info received from the corresponding remote device. The implementation details of this and other apps could be introduced in various ways by the community of software developers once the platform is suitably enabled.

An embodiment of a system includes an application host and a remote host. The application host extracts video, compresses the extracted video, and sends the compressed video. The application host receives touch information for use by an application running on the application host. The remote host comprises a touch-sensitive display 101. The remote host receives the compressed video from the application host, decompresses the compressed video, and reproduces the compressed video on the touch-sensitive display. Touches on the touch-sensitive display provide the touch information which is sent by the remote host to the application host.

According to a further embodiment, the application host comprises a display 301 and a network interface 307. The display displays the video which is extracted. The network interface 307 sends the compressed video to the remote host and receiving from the remote host the touch information for control of the application host.

According to a further embodiment, the network interface 307 comprises direct wireless connection to one or more remote hosts.

According to a further embodiment, the network interface 307 comprises a connection to a local network such as by a wireless modem and a wired connection.

According to a further embodiment, the remote host is handheld mobile device with a touch-sensitive flat-screen such as a smart phone and a tablet.

According to a further embodiment, the remote host comprises a network interface 107 for receiving the compressed video from the application host and sending the touch information to the application host.

According to a further embodiment the remote host comprises a system-on-chip SOC 100 for the decompressing of the compressed video and reproducing the compressed video on the touch-sensitive display.

According to a further embodiment, the remote host further comprises at least one audio port 102 for playing sound associated with the application running on the application host.

According to a further embodiment, the remote host further comprises one or more sensors such as cameras 103, microphones 104, motion sensors 105, position sensors 105, and environmental sensors 105.

According to a further embodiment properties of the sensors attached to the remote host are conveyed by the remote host to the application host after a network connection is established. Sensory information from one or more of the sensors is sent by the remote host to the application host, when such sensory information is requested by an application running on the application host. The sensory information from one or more of the sensors is received by the application host. The application host uses the sensory information from one or more of the sensors without regard to origin as if from sensors native to the application host.

According to a further embodiment the system includes a plurality of or many remote hosts. Each remote host comprises a sensor of the same type. Each of the same sensor type is hosted by a different remote device. Each of said same sensor type is accessible to a single application running on the application host.

According to a further embodiment, the application host further comprises an internal frame buffer 401, a downscaler 402, a frame controller 403, a video encoder 404, and a transmit buffer 406. The internal frame buffer 401 captures and store a copy of the video frames produced. The downscaler 402 is operatively coupled to the internal frame buffer 401 to downscale the resolution of each video frame. The frame controller 403 is operatively coupled to the downscaler 402 for regulating the amount of video data that is produced. The video encoder 404 is operatively coupled to the frame controller 403 to compress the frame signal in a fashion that minimize latency and produce a compressed frame signal. The transmit buffer 406 is operatively coupled to the video encoder 404 to transmit the compressed frame signal via a network interface 408 of the application host to the remote host. And according to this same further embodiment the remote host comprises a receive buffer 457, a decoder, and a touch display controller 451. The receive buffer 457 is operatively coupled to a network interface 458 to receive the compressed frame signal from the application host. The decoder 454 is operatively coupled to the receive buffer 457 to receive the compressed frame signal and reconstruct reconstructed video images. The touch display controller 451 is operatively coupled to the decoder 454 and the touch sensitive display to receive and display the reconstructed video images.

According to a further embodiment, the frame controller 403 of the application host maintains a limited number of encoding slots. If a slot is available when a next video frame is received from the downscaler 402, then the encoding slot is assigned to said next video frame and subsequently forwarded to the encoder 404. The frame controller 403 holds said encoding slot assigned to said next video frame until receipt of a notification of a successful transmission whereafter a state of the encoding slot is cleared and becomes available for reassignment.

According to a further embodiment, when the receive buffer 457 of the remote host receives a compressed video frame in its entirety, the notification is forwarded to transmit buffer 456 which forwards the message back to the application host via network interfaces 458 and 408 and the notification is received at receive buffer 407 of the application host and then forwarded to frame controller 403.

According to a further embodiment, the frame controller 403 is configured to process all frames in sequence without reordering.

According to a further embodiment, the encoder 404 is configured to avoid inserting I-frames except when necessary for synchronization with a new remote device connection.

According to a further embodiment, the rate controller 405 is responsive to information received from frame controller 403 and operatively coupled to the encoder 404 to manage the rate of output data produced by said encoder.

According to a further embodiment, the remote host further comprises a touch controller 451 operatively coupled to the transmit buffer 456 and the network interface 458 to transmit touch information. And the application host further comprises an input event controller 409 operatively coupled to the receive buffer 457 and the network interface 408. The input event controller 409 receives the touch information and correlate the touch information with overlaid video images when the display buffer 401 of the application host contains a same video displayed on the touch-sensitive display 101 of the remote host using the touch display controller 451 of the remote host.

According to a further embodiment, the application host comprises an input event controller 409 operatively coupled to receive the touch information from the remote host. The input event controller 409 correlates the touch information with overlaid video images when the application host contains a same video displayed on the touch-sensitive display 101 of the remote host.

According to a further embodiment, the application host further comprises a processor running an operating system, a first virtual device driver, a second virtual device driver, a first proxy subsystem, and a second proxy subsystem. The first virtual device driver receives from the operating system the video for forwarding to the remote host. The second virtual device driver supplies to the operating system the forwarded from the remote host. The first proxy subsystem forwards video from the first virtual device driver to the remote host. The second proxy subsystem forwards the touch information from the remote host to the first virtual device driver.

To summarize, the operating system running on the application host requires adjustment to support dynamic connection and disconnection of sensor devices, the number of connections to sensors of the same type should not be arbitrarily limited, and the APIs must be expanded to allow software applications to access the multiple sensors. The expanded APIs should include sufficient information to insure that the applications are able to properly identify the source of each sensor device. In some cases, it may be advantageous to implement and enforce a security policy before permitting a user of one mobile device to access the sensor devices corresponding to another user.

In conclusion, a system has an application host and a remote host with a touch-sensitive display has been disclosed. Video from the application host is extracted, compressed, forwarded, decompressed and reproduced on a touch-sensitive display. Touch information from the touch-sensitive display is received by the remote host and forwarded to the application host. The plurality of remote devices each hosts one or more sensors. Information from the one or more sensors on each remote device is forwarded to the application host and becomes usable to applications as if they were native sensors. Two or more sensors are of the same type, where each of said same sensors is hosted by a different remote device, and each of said same sensors is accessible to a single application running on the application host.

The signal processing techniques disclosed herein with reference to the accompanying drawings can be implemented on one or more digital signal processors (DSPs) or other microprocessors. Nevertheless, such techniques could instead be implemented wholly or partially as hardwired circuits. Further, it is appreciated by those of skill in the art that certain well known digital processing techniques are mathematically equivalent to one another and can be represented in different ways depending on choice of implementation.

Any letter designations such as (a) or (b) etc. used to label steps of any of the method claims herein are step headers applied for reading convenience and are not to be used in interpreting an order or process sequence of claimed method steps. Any method claims that recite a particular order or process sequence will do so using the words of their text, not the letter designations.

Unless stated otherwise, terms such as “first” and “second” are used to arbitrarily distinguish between the elements such terms describe. Thus, these terms are not necessarily intended to indicate temporal or other prioritization of such elements.

Any trademarks listed herein are the property of their respective owners, and reference herein to such trademarks is generally intended to indicate the source of a particular product or service.

Although the inventions have been described and illustrated in the above description and drawings, it is understood that this description is by example only, and that numerous changes and modifications can be made by those skilled in the art without departing from the true spirit and scope of the inventions. Although the examples in the drawings depict only example constructions and embodiments, alternate embodiments are available given the teachings of the present patent disclosure.

What is claimed is:

1. A system comprising:
an application host for extracting video, compressing the extracted video, and sending the compressed video; and the application host receives touch information for use by an application running on the application host; and
a remote host comprising a touch-sensitive display, wherein the remote host receives the compressed video from the application host, decompresses the compressed video, and reproduces the compressed video on the touch-sensitive display; and wherein touches on the touch-sensitive display provide the touch information which is sent by the remote host to the application host.

2. A system according to claim 1, wherein the application host comprises:
a display for displaying the video which is extracted; and
a network interface for sending the compressed video to the remote host and receiving from the remote host the touch information for control of the application host.

3. A system according to claim 2, wherein the network interface comprises direct wireless connection to one or more remote hosts.

4. A system according to claim 2, wherein the network interface comprises a connection to a local network and is chosen from the group consisting of a wireless modem and a wired connection.

5. A system according to claim 2, wherein the remote host is handheld mobile device with a touch-sensitive flat-screen chosen from the group consisting of a smart phone and a tablet.

6. A system according to claim 1, wherein the remote host comprises:
a network interface for receiving the compressed video from the application host and sending the touch information to the application host.

7. A system according to claim 1, wherein the remote host comprises:
a system-on-chip (SOC) for the decompressing of the compressed video and reproducing the compressed video on the touch-sensitive display.

8. A system according to claim 1, wherein the remote host further comprises at least one audio port for playing sound associated with the application running on the application host.

9. A system according to claim 1, wherein the remote host further comprises one or more sensors chosen from the group consisting of cameras, microphones, motion sensors, position sensors, and environmental sensors.

10. A system according to claim 9,
wherein properties of the sensors attached to the remote host are conveyed by the remote host to the application host after a network connection is established;
wherein sensory information from one or more of the sensors is sent by the remote host to the application host, when such sensory information is requested by an application running on the application host;
wherein the sensory information from one or more of the sensors is received by the application host; and
wherein the application host uses the sensory information from one or more of the sensors without regard to origin as if from sensors native to the application host.

11. A system according to claim 9, comprising a plurality of remote hosts, wherein each remote host comprises a sensor of the same type, wherein each of said same sensor type is hosted by a different remote device, and wherein each of said same sensor type is accessible to a single application running on the application host.

12. A system according to claim 1,
wherein the application host further comprises:
an internal frame buffer to capture and store a copy of the video frames produced;
a downscaler operatively coupled to the internal frame buffer to downscale the resolution of each video frame;
a frame controller operatively coupled to the downscaler to regulate an amount of video data that is produced and produce a frame signal;
a video encoder operatively coupled to the frame controller to compress the video frames in a fashion that minimizes latency and produces a compressed frame signal; and
a transmit buffer operatively coupled to the video encoder to transmit the compressed frame signal via a network interface of the application host to the remote host; and
wherein the remote host comprises:
a receive buffer operatively coupled to a network interface to receive the compressed frame signal from the application host;
a decoder operatively coupled to the receive buffer to receive the compressed frame signal and reconstruct reconstructed video images; and
a touch display controller operatively coupled to the decoder and the touch sensitive display to receive and display the reconstructed video images.

13. A system according to claim 12, wherein the frame controller of the application host maintains a limited number of encoding slots, if a slot is available when a next video frame is received from the downscaler, then the encoding slot is assigned to said next video frame and subsequently forwarded to the encoder, wherein the frame controller holds said encoding slot assigned to said next video frame until receipt of a notification of a successful transmission whereafter a state of the encoding slot is cleared and becomes available for reassignment.

14. A system according to claim 13, wherein when the receive buffer of the remote host receives a compressed video frame in its entirety, the notification is forwarded to transmit buffer which forwards the message back to the application host via network interfaces and the notification is received at receive buffer of the application host and then forwarded to frame controller.

15. A system according to claim 12, wherein the encoder is configured to process all frames in sequence without reordering.

16. A system according to claim 12, wherein the frame controller is configured to avoid inserting I-frames except when necessary for synchronization with a new remote device connection.

17. A system according to claim 12,
wherein the rate controller is responsive to information received from frame controller and operatively coupled to the encoder and the frame controller to send new rate information to encoder to manage a rate of output data produced by the encoder.

18. A system according to claim 12,
wherein the remote host further comprises
a touch controller operatively coupled to the transmit buffer and the network interface to transmit touch information; and
wherein the application host further comprises
an input event controller operatively coupled to the receive buffer and the network interface to receive the touch information and correlate the touch information with overlaid video images when the display buffer of the application host contains a same video displayed on the touch-sensitive display of the remote host using the touch display controller of the remote host.

19. A system according to claim 1, wherein the application host comprises an input event controller operatively coupled to receive the touch information from the remote host and correlate the touch information with overlaid video images when the application host contains a same video displayed on the touch-sensitive display of the remote host.

20. A system according to claim 1,
wherein the application host further comprises a processor running
an operating system;
a first virtual device driver for receiving from the operating system the video for forwarding to the remote host;
a second virtual device driver for supplying to the operating system the touch information forwarded from the remote host;
a first proxy subsystem for forwarding video from the first virtual device driver to the remote host; and
a second proxy subsystem for forwarding the touch information from the remote host to the first virtual device driver.

21. A method comprising the steps of:
(a) extracting video in an application host;
(b) compressing the extracted video in the application host;
(c) sending the compressed video in the application host;
(d) receiving touch information in the application host for use by an application running on the application host;
(e) receiving in a remote host the compressed video from the application host;
(f) decompressing the compressed video in the remote host;
(g) reproducing the compressed video on a touch-sensitive display of the remote host; and
(h) sending from the remote host to the application host the touch information from touches on the touch-sensitive display.

22. A method according to claim 21, further comprising the steps of
(i) displaying the video which is extracted on a display of the application host; and
(j) sending the compressed video to the remote host and receiving from the remote host the touch information for control of the application host.

23. A method according to claim 21, further comprising the step of (i) receiving the compressed video from the application host and sending the touch information to the application host.

24. A method according to claim 21, further comprising the steps of
(i) conveying to the application host properties of sensors attached to the remote host after a network connection is established;
(j) sending sensory information from one or more of the sensors from the remote host to the application host, when such sensory information is requested by an application running on the application host;
(k) receiving in the application host the sensory information from one or more of the sensors; and
(l) using in the application host the sensory information from one or more of the sensors without regard to origin as if from sensors native to the application host.

25. A method according to claim 21, wherein the method further comprises:
(i) capturing and storing in the application host a copy of the video frames produced;
(j) downscaling in the application host the resolution of each video frame produced in said step (i);
(k) regulating an amount of video data that is produced in the application host;
(l) video encoding in the application host to compress the frame signal produced by said step (k) in a fashion that minimizes latency and produces a compressed frame signal; and
(m) transmitting the compressed frame signal video encoded in said step (l) from the application host to the remote host;
(n) receiving in the remote host the compressed frame signal transmitted in said step (m) from the application host;
(o) decoding in the remote host the compressed frame signal received in said step (n) and reconstructing reconstructed video images; and
(p) displaying on the touch sensitive display in the remote host the reconstructed video images decoded in said step (o).
